(19) United States
(12) Patent Application Publication
(10) Pub. No.: US 2024/0365076 A1
(43) Pub. Date: Oct. 31, 2024

(54) AUDIO OUTPUT DEVICE AND INSPECTION METHOD

(71) Applicant: SONY GROUP CORPORATION, TOKYO (JP)

(72) Inventors: YOSHIYUKI KURODA, TOKYO (JP); GO IGARASHI, TOKYO (JP)

(21) Appl. No.: 18/685,238

(22) PCT Filed: Mar. 10, 2022
(86) PCT No.: PCT/JP2022/010489

§ 371 Date: Feb. 21, 2024

(30) Foreign Application Priority Data
Sep. 7, 2021 (JP) 2021-145701

(51) Int. Cl. H04R 29/00; G01B 21/16; H04R 1/02

(52) U.S. Cl. CPC H04R 29/002; G01B 21/16; H04R 1/025

(57) ABSTRACT

The present technology relates to an audio output device and an inspection method capable of easily detecting the presence or absence of abnormality of an actuator. An audio output device according to the present technology includes: a plurality of actuators that vibrates a diaphragm from the back surface side to output audio from the front surface side of the diaphragm; and a determination unit that determines presence or absence of abnormality of an inspection target actuator to be inspected among the actuators on the basis of a displacement signal from a measurement actuator arranged in the vicinity of the inspection target actuator, the displacement signal being output in response to vibration of the inspection target actuator. The present technology can be applied to, for example, a display device having a large-screen display unit such as an LED display.

### TECHNICAL FIELD

The present technology relates to an audio output device and an inspection method, and more particularly to an audio output device and an inspection method capable of easily detecting the presence or absence of abnormality of an actuator.

### BACKGROUND ART

In display devices having a large-screen display unit such as an LED display, a speaker may be placed on the back surface of the display unit. In a case where the speaker is placed on the back surface, audio output from the speaker is blocked by the display unit, and thus the viewer cannot obtain an experience of integrated image and audio such that the viewer feels that the sources of the image and the sound match.

In order to provide the experience of integrated image and audio, for example, Patent Document 1 proposes a technique in which a speaker array is arranged at the end of a display and an audio image is localized in a screen by the speaker array.

### CITATION LIST

### Patent Document

Patent Document 1: Japanese Patent Application Laid-Open No. 2012-235426

### SUMMARY OF THE INVENTION

### Problems to be Solved by the Invention

An audio image can be localized in the screen by arranging a plurality of actuators on an LED display substrate constituting the LED display and vibrating the LED display substrate.

In this case, since a plurality of actuators is arranged on one LED display substrate, it is difficult to detect the presence or absence of abnormality of each actuator.

The present technology has been made in view of such a situation, and makes it possible to easily detect the presence or absence of abnormality of an actuator.

### Solutions to Problems

An audio output device according to a first aspect of the present technology includes: a plurality of actuators that vibrates a diaphragm from the back surface side to output audio from the front surface side of the diaphragm; and a determination unit that determines the presence or absence of abnormality of an inspection target actuator to be inspected among the actuators on the basis of a displacement signal from a measurement actuator arranged in the vicinity of the inspection target actuator, the displacement signal being output in response to vibration of the inspection target actuator.

In an inspection method according to a second aspect of the present technology, an audio output device determines the presence or absence of abnormality of an inspection target actuator on the basis of a displacement signal from a measurement actuator arranged in the vicinity of the inspection target actuator, the displacement signal being output in response to vibration of the inspection target actuator to be inspected among a plurality of actuators that vibrates a diaphragm from the back surface side to output audio from the front surface side of the diaphragm.

In the first aspect of the present technology, a plurality of actuators vibrates a diaphragm from the back surface side to output audio from the front surface side of the diaphragm, and the presence or absence of abnormality of an inspection target actuator to be inspected among the actuators is determined on the basis of a displacement signal from a measurement actuator arranged in the vicinity of the inspection target actuator, the displacement signal being output in response to vibration of the inspection target actuator.

In the second aspect of the present technology, the presence or absence of abnormality of an inspection target actuator is determined on the basis of a displacement signal from a measurement actuator arranged in the vicinity of the inspection target actuator, the displacement signal being output in response to vibration of the inspection target actuator to be inspected among a plurality of actuators that vibrates a diaphragm from the back surface side to output audio from the front surface side of the diaphragm.

### BRIEF DESCRIPTION OF DRAWINGS

FIG. 1 is a view illustrating an appearance of a display device to which the present technology is applied.

FIG. 2 is a front view illustrating a configuration example of a display unit.

FIG. 3 is an enlarged side view of a display module.

FIG. 4 is a diagram illustrating an arrangement example of actuators.

FIG. 5 is a block diagram illustrating a configuration example of the display module.

FIG. 6 is a diagram illustrating an example of light emission of an LED according to the presence or absence of abnormality of an actuator.

FIG. 7 is a flowchart for explaining processing performed by the display module.

FIG. 8 is a flowchart for explaining switching processing performed in step S1 in FIG. 7.

FIG. 9 is a diagram illustrating an example of a reference table.

FIG. 10 is a diagram illustrating an example of switching of a switch.

FIG. 11 is a diagram illustrating another arrangement example of the actuators.

FIG. 12 is a diagram illustrating another example of the reference table.

FIG. 13 is a view illustrating an appearance of an audio output unit.

### MODE FOR CARRYING OUT THE INVENTION

1. Appearance of Display Device
2. Configuration of Display Module
3. Operation of Display Module
4. Modifications

### 1. Appearance of Display Device

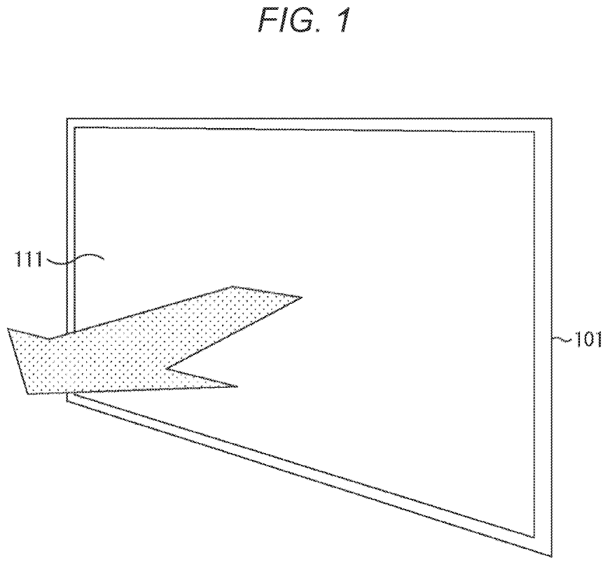

FIG. 1 is a view illustrating an appearance of a display device 101 to which the present technology is applied. FIG. 1 illustrates the appearance of the display device 101 in a case where the display device 101 is viewed diagonally from the front.

As illustrated in FIG. 1, the display device 101 is configured by surrounding a display unit 111 that is a light emitting diode (LED) display, with narrow frame members in the vertical and horizontal directions. The display device 101 may be configured with the display unit 111 not surrounded by the frame member.

The display device 101 outputs, for example, an image and audio obtained by reproducing content of a moving image. In the display device 101, the image is displayed on the display unit 111. Furthermore, the audio is output from the display unit 111 itself as indicated by the arrow in FIG. 1. The output of the audio using the display unit 111 is realized by vibrating the display unit 111 as described later.

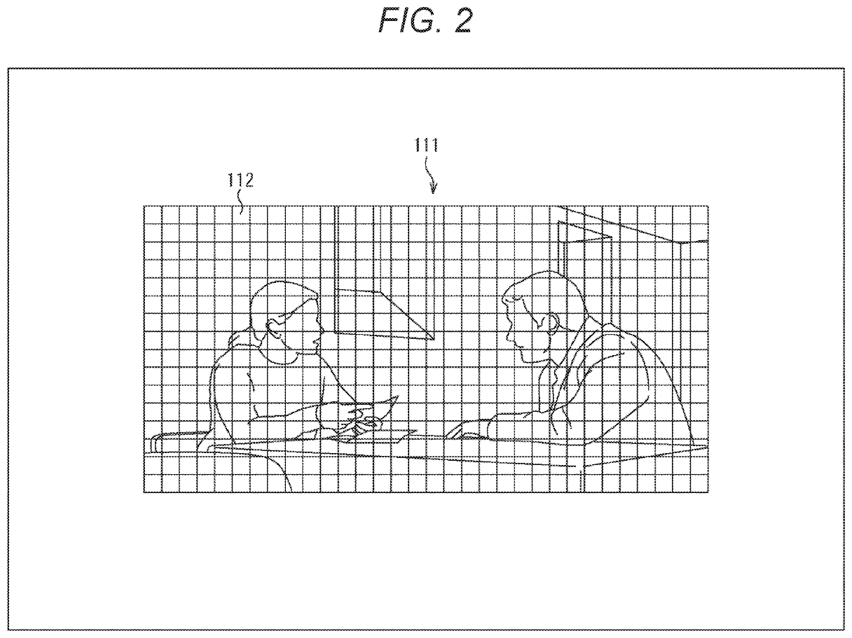

FIG. 2 is a front view illustrating a configuration example of the display unit 111.

As indicated by separating with a solid line, the display unit 111 is configured by arranging and combining a plurality of display modules 112 vertically and horizontally.

In the example of FIG. 2, the display unit 111 is configured by combining a total of 512 rectangular display modules 112, 32 in the horizontal direction and 16 in the vertical direction. The number of the display modules 112 constituting the display unit 111 can be appropriately changed according to the size of the display device 101. The display device 101 is a tiling display system configured by combining any number of the display modules 112.

The front surface of each display module 112 is an image display unit. As illustrated in FIG. 2, for example, an image is displayed by using an entire plurality of the image display units as one display surface.

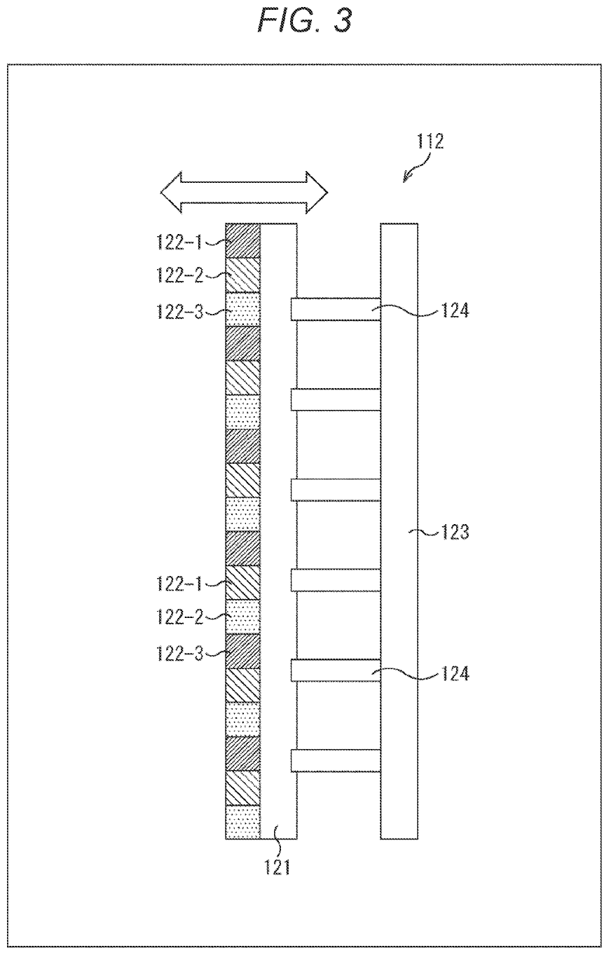

FIG. 3 is an enlarged side view of the display module 112.

As illustrated in FIG. 3, LEDs 122-1 to 122-3 are arranged in an array on the front surface of a thin plate-shaped LED display substrate 121. The LED 122-1 is a light emitting element that emits red light, and the LED 122-2 is a light emitting element that emits green light. The LED 122-3 is a light emitting element that emits blue light. The LEDs 122-1 to 122-3 emit light to display an image. In a case where it is not necessary to distinguish the LEDS 122-1 to 122-3, the LEDs 122-1 to 122-3 are simply referred to as LEDs 122.

On the back surface side of the LED display substrate 121, a base member 123 is provided with a predetermined gap. The back surface of the LED display substrate 121 is attached to a plurality of actuators 124 fixed to the base member 123.

The base member 123 is a member that supports the LED display substrate 121, the actuator 124, and the like.

The actuator 124 includes a piezo actuator, a voice coil actuator, and the like. The actuator 124 vibrates in response to an audio signal, so that, for example, as indicated by the double-headed arrow in FIG. 3, vibration in the thickness direction of the LED display substrate 121 is transmitted to the LED display substrate 121. The actuator 124 vibrates the LED display substrate 121 from the back surface side, so that audio is output from the front surface side of the LED display substrate 121.

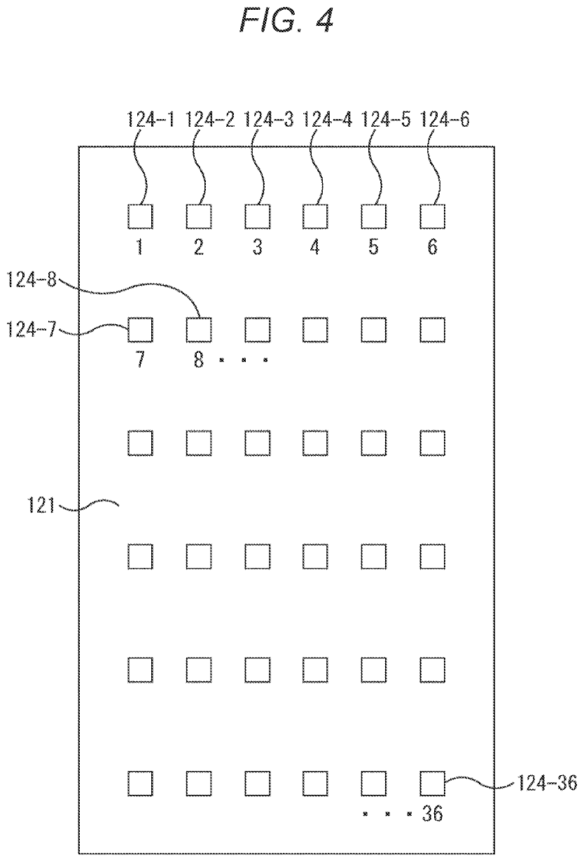

FIG. 4 is a diagram illustrating an arrangement example of the actuators 124. In FIG. 4, the arrangement of the actuators 124 as viewed from the front surface side is indicated by a rectangle.

As illustrated in FIG. 4, for example, 36 actuators 124-1 to 124-36 are arranged such that six actuators are arranged in the horizontal direction at regular intervals on the LED display substrate 121. Hereinafter, the actuators 124-1 to 124-36 are also referred to as actuators 1 to 36, respectively.

### 2. Configuration of Display Module

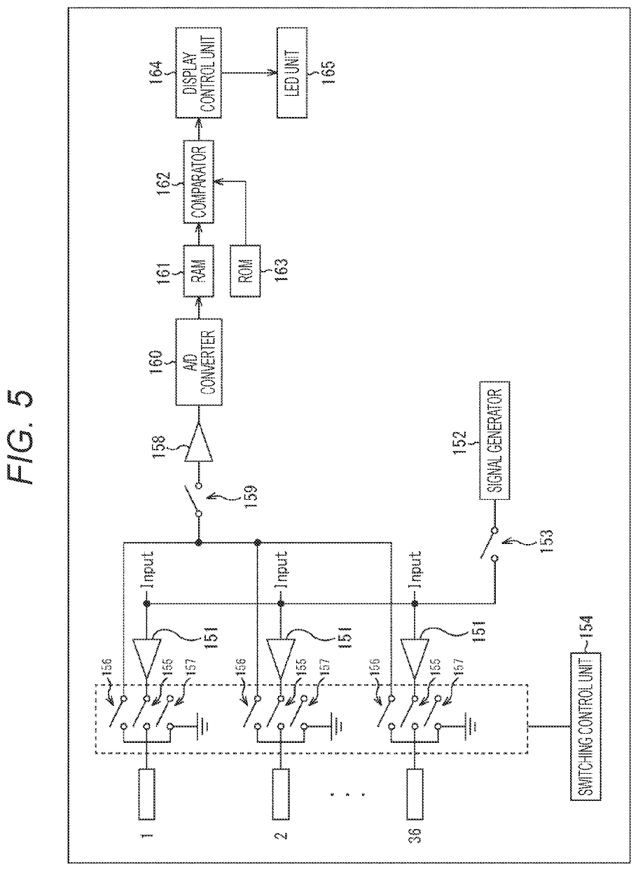

FIG. 5 is a block diagram illustrating a configuration example of the display module 112.

As illustrated in FIG. 5, the display module 112 includes the actuators 1 to 36, a driving amplifier 151, a signal generator 152, a switch 153, a switching control unit 154, a switch 155, a switch 156, a switch 157, a measurement amplifier 158, a switch 159, an A/D converter 160, a random access memory (RAM) 161, a comparator 162, a read only memory (ROM) 163, a display control unit 164, and an LED unit 165. The driving amplifier 151 and the switches 155, 156, and 157 are provided for each of the actuators 1 to 36.

The actuators 1 to 36 are connected to the driving amplifier 151 via the switch 155. Furthermore, the actuators 1 to 36 are connected to the measurement amplifier 158 via the switch 155 and the switch 159. The actuators 1 to 36 are connected to a ground (GND) via a switch 157.

The actuators 1 to 36 vibrate according to an audio signal or an inspection signal supplied from the driving amplifier 151. Furthermore, the actuators 1 to 36 also function as a displacement sensor that measures displacement of the LED display substrate 121 caused in response to vibration of another actuator. The actuators 1 to 36 supply a displacement signal indicating the displacement of the LED display substrate 121 to the measurement amplifier 158 via the switch 156 and the switch 159.

The driving amplifier 151 provided for each of the actuators 1 to 36 amplifies and outputs an audio signal input thereto or an inspection signal supplied from the signal generator 152, and drives the actuators 1 to 36. The inspection signal is a signal that vibrates an inspection target actuator that is an actuator to be inspected for the presence or absence of abnormality.

The signal generator 152 generates the inspection signal to be supplied to the driving amplifier 151 via the switch 153.

The switching control unit 154 switches an inspection target actuator and a measurement actuator by switching on and off of the switch 155, the switch 156, and the switch 157 of each of the actuators 1 to 36. The measurement actuator is an actuator that functions as a displacement sensor that measures displacement of the LED display substrate 121 caused by vibration of the inspection target actuator. Switching between the inspection target actuator and the measurement actuator will be described later.

The measurement amplifier 158 amplifies the displacement signal supplied from the measurement actuator to be supplied to the A/D converter 160.

The A/D converter 160 converts the displacement signal supplied from the measurement amplifier 158 into a digital signal to be supplied to the RAM 161.

The RAM 161 stores the displacement signal supplied from the A/D converter 160.

The comparator 162 acquires the displacement signal from the RAM 161. Furthermore, the comparator 162 acquires a reference signal for the inspection target actuator from the ROM 163. The comparator 162 functions as a determination unit that determines the presence or absence of abnormality of the inspection target actuator by comparing the displacement signal with the reference signal. For example, in a case where an error between the displacement signal and the reference signal exceeds a reference value, the comparator 162 determines that the inspection target actuator is abnormal.

The comparator 162 supplies information indicating the presence or absence of abnormality of the inspection target actuator to the display control unit 164.

The ROM 163 records, as a reference signal, a displacement signal acquired by measuring displacement of the LED display substrate 121 caused by vibration of the inspection target actuator in advance by a measurement actuator in an inspection at shipment or the like.

The reference signal is recorded in the ROM 163 for each combination of the inspection target actuator and the measurement actuator. By using the reference signal corresponding to the combination of the inspection target actuator and the measurement actuator, the comparator 162 can determine the presence or absence of the abnormality with high accuracy than the case of using a predetermined reference signal for the inspection target actuator.

The display control unit 164 causes the LED unit 165 to display an image by controlling light emission thereof. Furthermore, the display control unit 164 turns on the LEDs 122 arranged at positions corresponding to the actuators 1 to 36 among the plurality of LEDs 122 constituting the LED unit 165 on the basis of the information supplied from the comparator 162.

The LED unit 165 includes the plurality of LEDs 122 provided on the front surface of the LED display substrate 121. Each of the plurality of LEDs 122 emits light under the control by the display control unit 164.

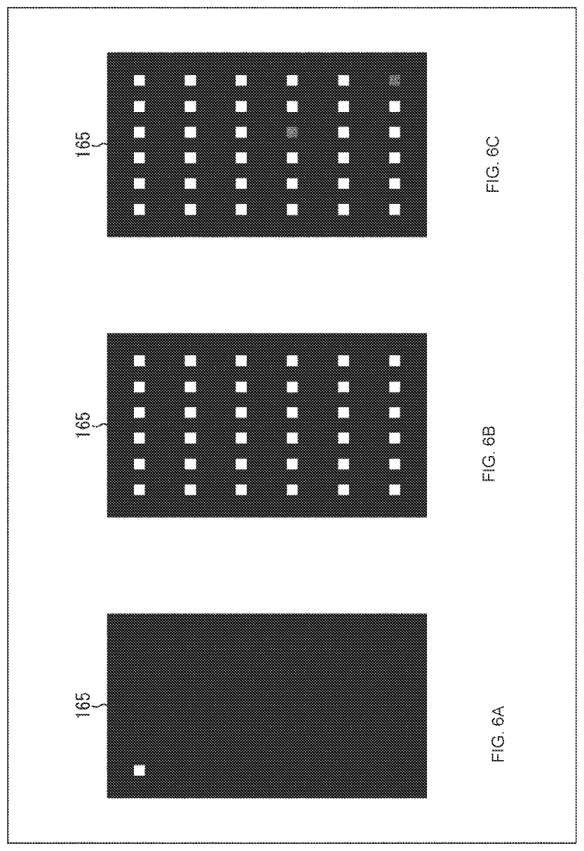

FIG. 6 is a diagram illustrating an example of light emission of an LED according to the presence or absence of abnormality of the actuators 1 to 36.

For example, it is assumed that the presence or absence of abnormality is determined one by one in order from the actuator 1 among the actuators 1 to 36. In this case, the LED 122 arranged at the position corresponding to the position of the actuator where the determination of the presence or absence of the abnormality has been made is turned on according to the determination result of the presence or absence of the abnormality.

First, in a case where it is determined that the actuator is normal, as illustrated in A of FIG. 6, among the LEDs 122 constituting the LED unit 165, for example, the LED 122 arranged at the position on the front surface side of the position of the actuator 1 is turned on in green. In FIG. 6, a white rectangle indicates the LED 122 that is being turned on in green.

Thereafter, in a case where it is determined that each of the actuators 2 to 36 is normal, as illustrated in B of FIG. 6, for example, the LED 122 arranged at the position on the front surface side of each of the positions of the actuators 2 to 36 is also turned on in green.

For example, in a case where it is determined that, among the actuators 1 to 36, the actuator 22 and the actuator 36 are abnormal and the other actuators are normal, the LEDs 122 arranged on the front surface side of the positions of the actuator 22 and the actuator 36 are turned on in red. The LEDS 122 arranged on the front surface side of the positions of the other actuators are turned on in green. In FIG. 6, colored rectangles indicate the LEDs 122 that are being turned on in red.

In the example of FIG. 6, the LED 122 is turned on in green in a case where the actuator is normal, and is turned on in red in a case where the actuator is abnormal, but the color to be turned on is not limited thereto. Furthermore, the LED 122 may be turned on/blink or may have a different blinking cycle according to the determination result of the presence or absence of abnormality.

### 3. Operation of Display Module

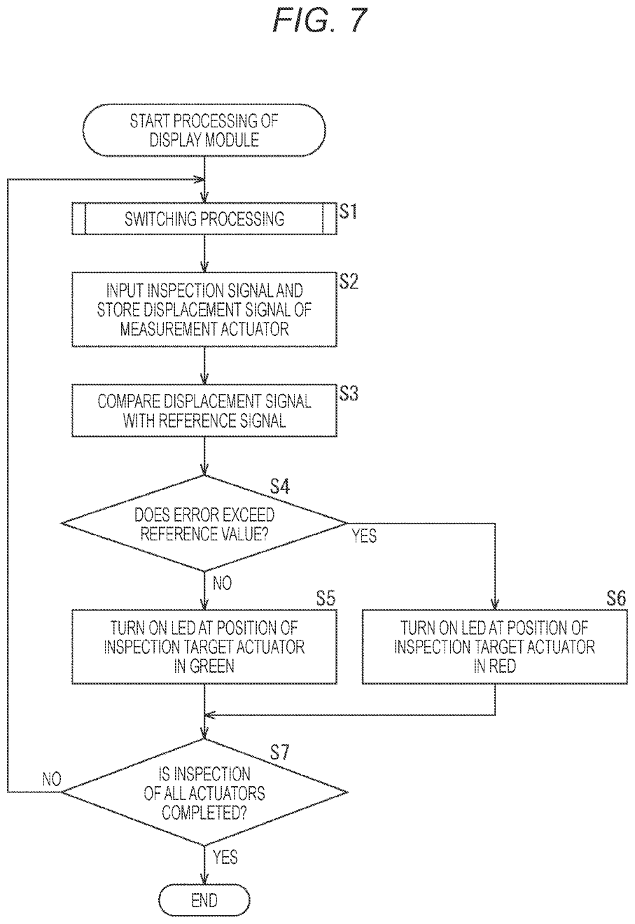

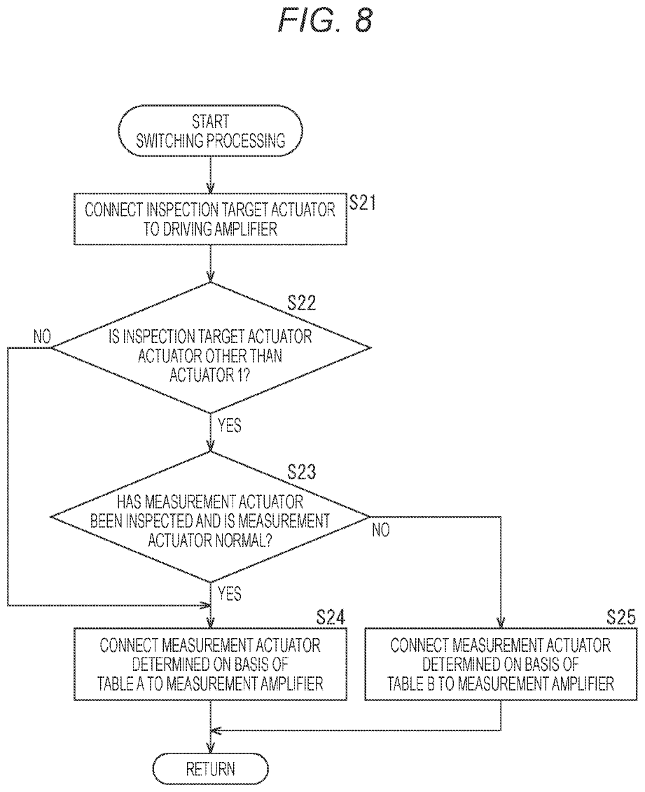

Processing performed by the display module 112 having the above-described configuration will be described with reference to a flowchart of FIG. 7. The processing of FIG. 7 is started in a state where the signal generator 152 and the driving amplifier 151 are connected by turning on the switch 153, for example. In step S1, the switching control unit 154 performs switching processing. The inspection target actuator and the measurement actuator are switched by the switching processing. The switching processing will be described later with reference to FIG. 8.

In step S2, the driving amplifier 151 inputs the inspection signal generated by the signal generator 152 to the inspection target actuator. The RAM 161 stores the displacement signal from the measurement actuator output in response to vibration of the inspection target actuator with the inspection signal. Here, the displacement signal amplified by the measurement amplifier 158 and converted into a digital signal by the A/D converter 160 is stored in the RAM 161.

In step S3, the comparator 162 compares the displacement signal stored in the RAM 161 with the reference signal recorded in the ROM 163.

In step S4, the comparator 162 determines whether or not an error between the displacement signal and the reference signal exceeds a reference value.

In a case where it is determined in step S4 that the error exceeds the reference value, that is, in a case where it is determined that the inspection target actuator is normal, in step S5, the display control unit 164 turns on the LED 122 arranged at the position corresponding to the position of the inspection target actuator in green.

On the other hand, in a case where it is determined in step S4 that the error does not exceed the reference value, that is, in a case where it is determined that the inspection target actuator is abnormal, in step S6, the display control unit 164 turns on the LED 122 arranged at the position corresponding to the position of the inspection target actuator in red.

After step S5 or step S6, the process proceeds to step S7. In step S7, the display module 112 determines whether or not the inspection of the presence or absence of abnormality of all the actuators is completed.

In a case where it is determined in step S7 that the inspection of some actuators has not been completed, the actuators for which the inspection has not been completed are set as the inspection target actuators, the process returns to step S1, and the subsequent processing is repeatedly performed.

On the other hand, in a case where it is determined in step S7 that the inspection of all the actuators has been completed, the process ends.

The switching processing performed in step S1 of FIG. 7 will be described with reference to a flowchart of FIG. 8.

In step S21, the switching control unit 154 turns on the switch 155 of the actuator serving as the inspection target actuator to connect the inspection target actuator to the driving amplifier 151.

In step S22, the switching control unit 154 determines whether or not the inspection target actuator is an actuator other than the actuator 1.

In a case where it is determined in step S22 that the inspection target actuator is an actuator other than the actuator 1, in step S23, the switching control unit 154 determines whether or not the measurement actuator registered in the table A has been inspected and is normal.

The switching control unit 154 determines the measurement actuator on the basis of a reference table in which the combination of the inspection target actuator and the measurement actuator is registered. In the reference table referred to by the switching control unit 154, the measurement actuator of the table A and the measurement actuator of the table B are registered for one inspection target actuator.

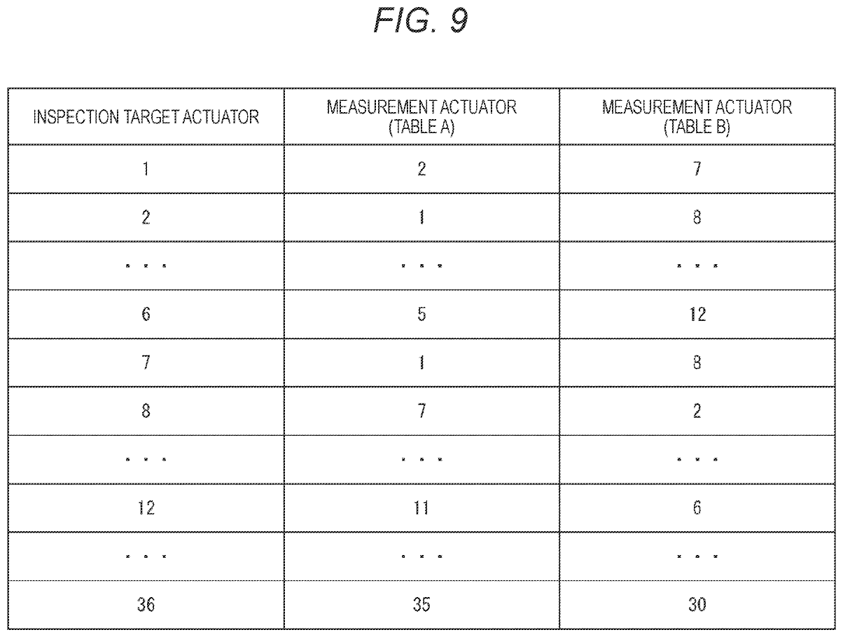

FIG. 9 is a diagram illustrating an example of the reference table.

For example, with respect to the actuator 1 as the inspection target actuator, as illustrated in FIG. 9, the actuator 2 is registered as the measurement actuator of the table A, and the actuator 7 is registered as the measurement actuator of the table B.

For example, with respect to the actuator 2 as the inspection target actuator, as illustrated in FIG. 9, the actuator 1 is registered as the measurement actuator of the table A, and the actuator 8 is registered as the measurement actuator of the table B.

As described above, in the reference table, as the measurement actuators of the table A with respect to the inspection target actuators excluding the actuator 1, the actuators that are arranged in the vicinity of the inspection target actuator and are inspected for the presence or absence of abnormality before the inspection target actuator are registered.

Note that since the inspection of the presence or absence of abnormality of the actuator 1 is performed first, there is no actuator to be inspected before the actuator 1. Therefore, in the reference table, the actuator 2 arranged in the vicinity of the actuator 1 is registered as the measurement actuator of the table A with respect to the actuator 1.

Furthermore, in the reference table, the actuator arranged in the vicinity of the inspection target actuator is registered as the measurement actuator of the table B with respect to the inspection target actuator.

Returning to FIG. 8, in a case where it is determined in step S23 that the measurement actuator of the table A for the inspection target actuator has been inspected and is normal, in step S24, the switching control unit 154 connects the measurement actuator determined on the basis of the table A to the measurement amplifier 158.

In a case where it is determined in step S22 that the inspection target actuator is the actuator 1, the processing of step S24 is also performed.

On the other hand, in a case where it is determined in step S23 that the measurement actuator of the table A for the inspection target actuator has not been inspected or is abnormal, in step S25, the switching control unit 154 connects the measurement actuator determined on the basis of the table B to the measurement amplifier 158.

Note that, in step S24 and step S25, the measurement actuator and the measurement amplifier 158 are connected by turning on the switch 156 and the switch 159 corresponding to the measurement actuator.

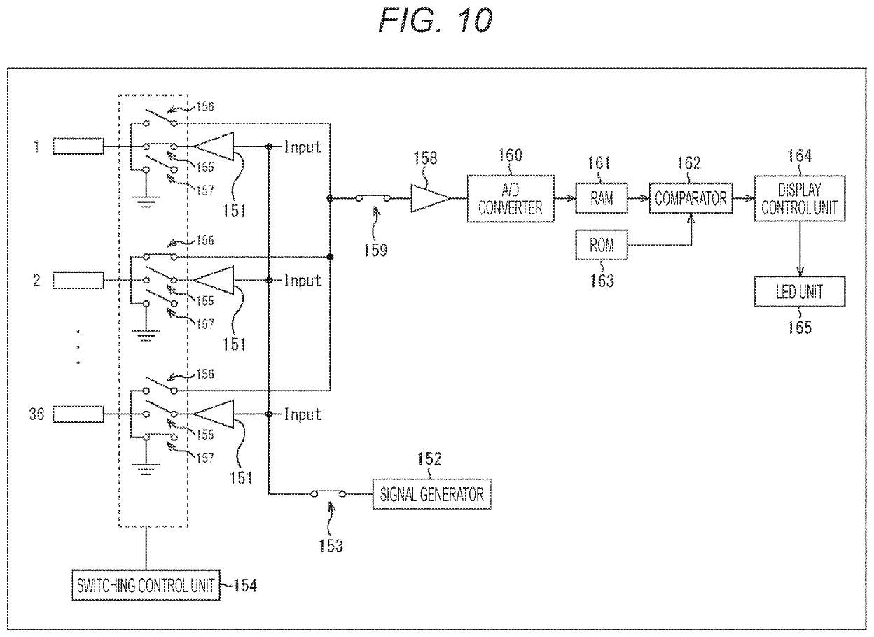

FIG. 10 is a diagram illustrating an example of switching of the switch.

When the actuator is inspected, the signal generator 152 and the driving amplifier 151 are connected by turning on the switch 153 as illustrated in FIG. 10.

In a case where the inspection target actuator is the actuator 1, the actuator 1 and the driving amplifier 151 are connected by turning on the switch 155 of the actuator 1.

Furthermore, by turning on the switch 156 and the switch 159 of the actuator 2, the actuator 2 as a measurement actuator and the measurement amplifier 158 are connected.

At this time, by turning on the switches 157 of the actuators 3 to 36, the actuators 3 to 36, which are not the inspection target actuator or the measurement actuator, are short-circuited to GND.

After the inspection target actuator and the measurement actuator are switched by such switching of the switch, the process returns to step S1 of FIG. 7, and the subsequent processing is performed.

As described above, in the display module 112, the presence or absence of abnormality of the inspection target actuator is determined on the basis of the displacement signal from the measurement actuator output according to the vibration of the inspection target actuator among the actuators that vibrate the LED display substrate 121 to output the audio. The presence or absence of the abnormality of the inspection target actuator is presented to the user by the light emission of the LED arranged at the position corresponding to the inspection target actuator according to the presence or absence of abnormality of the inspection target actuator.

Conventionally, as the number of display modules constituting the display unit increases, the number of actuators provided in the entire display unit increases, and thus it is difficult to detect the presence or absence of abnormality of each actuator.

In the display device 101 of the present technology, the presence or absence of abnormality of each actuator can be detected by causing the actuator that outputs audio from the LED display substrate 121 to also function as a displacement sensor. The user can easily detect the presence or absence of abnormality of each actuator by looking at the color of the LED 122 emitting light, and repair only the abnormal actuator, for example.

### 4. Modifications

### Arrangement Example of Actuator

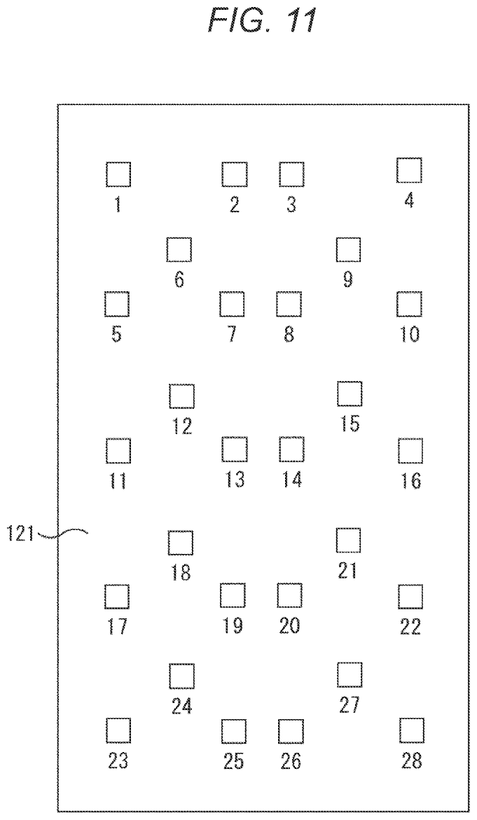

FIG. 11 is a diagram illustrating another arrangement example of the actuators 124. In FIG. 11, the arrangement of the actuators 124 as viewed from the front surface side is indicated by a rectangle.

In the example of FIG. 11, 28 actuators 1 to 28 are arranged on the LED display substrate 121 such that four actuators are arranged in the first row and six actuators are arranged in the second row to the fifth row.

In the first row, the actuators 124 are arranged at such positions that the second and fourth actuators among the six actuators arranged in the horizontal direction at regular intervals are excluded. In the second row to the fifth row, the actuators 124 are arranged at such positions that the second and fourth actuators among the six actuators arranged in the horizontal direction at regular intervals are shifted upward.

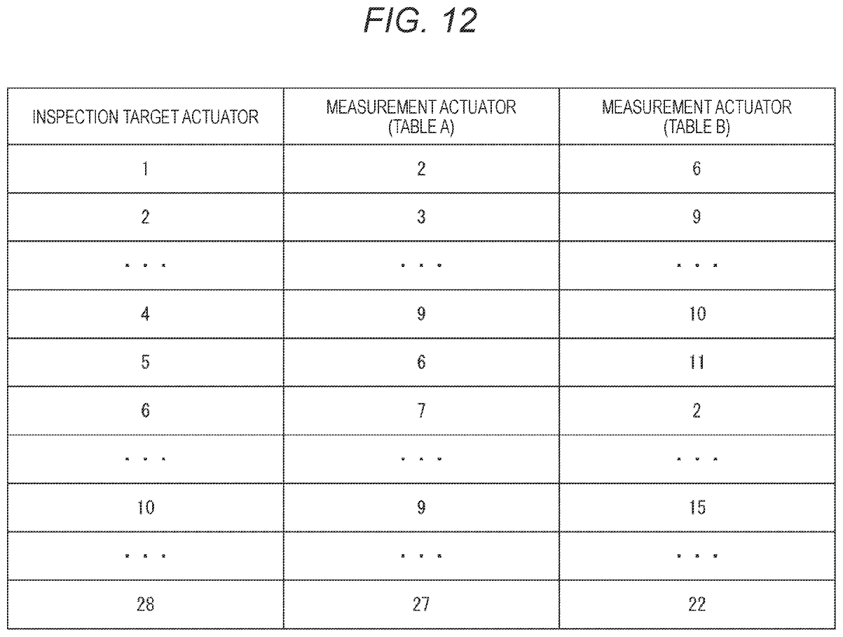

FIG. 12 is a diagram illustrating another example of the reference table.

In a case where the actuators 1 to 28 are arranged as illustrated in FIG. 11, the measurement actuator of the table A and the measurement actuator of the table B are registered with respect to the inspection target actuator as illustrated in FIG. 12.

For example, with respect to the actuator 1 as the inspection target actuator, as illustrated in the second row of FIG. 12, the actuator 2 is registered as the measurement actuator of the table A, and the actuator 6 is registered as the measurement actuator of the table B.

For example, with respect to the actuator 2 as the inspection target actuator, as illustrated in the third row of FIG. 12, the actuator 3 is registered as the measurement actuator of the table A, and the actuator 9 is registered as the measurement actuator of the table B.

In the reference table, for example, the actuator arranged at a position closest to the inspection target actuator is registered as the measurement actuator of the table A with respect to the inspection target actuator. Furthermore, in the reference table, for example, the actuator arranged at a position second closest to the inspection target actuator is registered as the measurement actuator of the table B with respect to the inspection target actuator.

As described above, even in a case where the actuators are unevenly arranged, the measurement actuator can be determined on the basis of the table A and the table B of the reference table.

Note that, in addition to the arrangement examples illustrated in FIGS. 4 and 11, the actuator may be arranged in another regular arrangement such as a staggered arrangement, or may be arranged in a completely random arrangement.

### Configuration Example of Display Unit 111

The display unit 111 may be configured by combining the display module 112 provided with the actuator and the display module not provided with the actuator.

### Light Emitting Element

The display module 112 may be configured such that the actuator is provided on the back surface side of the substrate on which another light emitting element other than the LED is provided on the front surface side.

### Configuration Example of Audio Output Unit

Although an example in which audio is output from the LED display substrate 121 on which the LEDs for displaying an image are arranged is described, audio may be output from a diaphragm on which a light emitting element such as an LED is not arranged.

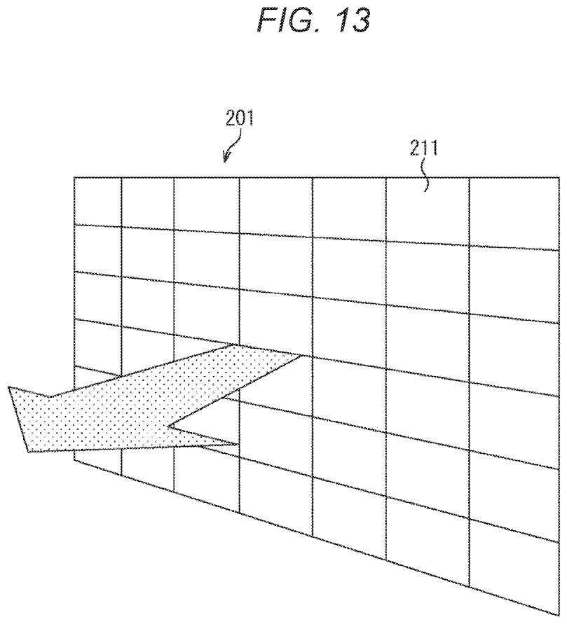

FIG. 13 is a view illustrating an appearance of an audio output unit 201.

As illustrated in FIG. 13, the audio output unit 201 is configured by combining, for example, 42 diaphragms 211 each provided with a plurality of actuators on the back surface side thereof. The actuator vibrates the diaphragm 211, so that audio is output from the front surface side of the audio output unit 201 as indicated by the arrow in FIG. 13.

In a case where the audio output device of the present technology includes the audio output unit 201 as illustrated in FIG. 13, the determination result of the presence or absence of the abnormality may be output to a terminal device such as a PC connected to the audio output device, may be recorded in a recording medium attached to the audio output device, or may be transmitted to a predetermined device via a network.

### Others

Note that, in the present specification, a system means an assembly of a plurality of components (devices, modules (parts), and the like), and it does not matter whether or not all the components are located in the same housing. Therefore, a plurality of devices housed in separate housings and coupled via a network and one device in which a plurality of modules is housed in one housing are both systems.

Note that the effects described in the present specification are merely examples and are not limited, and there may be other effects.

The embodiment of the present technology is not restricted to the embodiments described above, and various modifications can be made without departing from the spirit of the present technology.

Furthermore, each step described in the flowcharts described above may be executed by one device, or may be executed by a plurality of devices in a shared manner.

Moreover, in a case where a plurality of processing is included in one step, the plurality of processing included in one step can be executed by one device or by a plurality of devices in a shared manner.

### Example of Configuration Combinations

The present technology can also be configured as follows.

(1)

An audio output device including:
a plurality of actuators that vibrates a diaphragm from the back surface side to output audio from the front surface side of the diaphragm; and
a determination unit that determines presence or absence of abnormality of an inspection target actuator to be inspected among the actuators on the basis of a displacement signal from a measurement actuator arranged in the vicinity of the inspection target actuator, the displacement signal being output in response to vibration of the inspection target actuator.

(2)

The audio output device according to (1),
in which the determination unit determines presence or absence of abnormality of the inspection target actuator by comparing the displacement signal output from the measurement actuator in response to vibration of the inspection target actuator with a reference signal recorded in advance for the measurement actuator.

(3)

The audio output device according to (2),
in which the determination unit determines that the inspection target actuator is abnormal in a case where an error of the displacement signal from the reference signal exceeds a reference value.

(4)

The audio output device according to (2) or (3), further including
a switching control unit that switches between the inspection target actuator and the measurement actuator using a switch.

(5)

The audio output device according to (4),
in which the switching control unit determines the measurement actuator on the basis of a table in which a combination of the inspection target actuator and the measurement actuator is registered.

(6)

The audio output device according to (5),
in which a first actuator and a second actuator arranged in the vicinity of the inspection target actuator among the plurality of actuators are registered in the table as the measurement actuators in association with the inspection target actuator, and
the switching control unit determines the first actuator as the measurement actuator in a case where the first actuator is determined to be normal, and determines the second actuator as the measurement actuator in a case where the first actuator is determined to be abnormal.

(7)

The audio output device according to (6),
in which as the first actuator, the actuator in which presence or absence of abnormality is determined before the inspection target actuator is registered in the table.

(8)

The audio output device according to any one of (2) to (7), further including
a recording unit that records the reference signal for each combination of the inspection target actuator and the measurement actuator,
in which the determination unit acquires the reference signal corresponding to the combination from the recording unit.

(9)

The audio output device according to any one of (1) to (8),
in which the diaphragm is a display substrate on which a light emitting element for displaying an image is arranged. (10)

The audio output device according to (9) further including
a presentation control unit that presents presence or absence of abnormality of the inspection target actuator. (11)

The audio output device according to (10),
in which the presentation control unit causes the light emitting element arranged at a position corresponding to each of the plurality of actuators to emit light according to presence or absence of abnormality of the inspection target actuator.

(12)

The audio output device according to any one of (9) to (11), in which the display substrate constitutes a tiling display. (13)

The audio output device according to any one of (1) to (7), further including
an audio output unit that is configured by combining a plurality of the diaphragms.

(14)

The audio output device according to any one of (1) to (13), further including
a signal generation unit that generates an inspection signal for vibrating the inspection target actuator.

(15)

The audio output device according to any one of (1) to (14),
in which the actuator is a piezo actuator.

(16)

The audio output device according to any one of (1) to (14),
in which the actuator is a voice coil actuator.

(17)

An inspection method,
in which an audio output device including
determining presence or absence of abnormality of an inspection target actuator on the basis of a displacement signal from a measurement actuator arranged in the vicinity of the inspection target actuator, the displacement signal being output in response to vibration of the inspection target actuator to be inspected among a plurality of actuators that vibrates a diaphragm from the back surface side to output audio from the front surface side of the diaphragm.

### REFERENCE SIGNS LIST

101 Display device
111 Display unit
112 Display module
121 LED display substrate
122 LED
123 Base member
124 Actuator
151 Driving amplifier
152 Signal generator
153 Switch
154 Switching control unit
155 to 157 Switch
158 Measurement amplifier
159 Switch
160 A/D converter
161 RAM
162 Comparator
163 ROM
164 Display control unit
165 LED unit
201 Audio output unit
211 Diaphragm

1. An audio output device comprising:
a plurality of actuators that vibrates a diaphragm from a back surface side to output audio from a front surface side of the diaphragm; and
a determination unit that determines presence or absence of abnormality of an inspection target actuator to be inspected among the actuators on a basis of a displacement signal from a measurement actuator arranged in a vicinity of the inspection target actuator, the displacement signal being output in response to vibration of the inspection target actuator.

2. The audio output device according to claim 1,
wherein the determination unit determines presence or absence of abnormality of the inspection target actuator by comparing the displacement signal output from the measurement actuator in response to vibration of the inspection target actuator with a reference signal recorded in advance for the measurement actuator.

3. The audio output device according to claim 2,
wherein the determination unit determines that the inspection target actuator is abnormal in a case where an error of the displacement signal from the reference signal exceeds a reference value.

4. The audio output device according to claim 2, further comprising
a switching control unit that switches between the inspection target actuator and the measurement actuator using a switch.

5. The audio output device according to claim 4,
wherein the switching control unit determines the measurement actuator on a basis of a table in which a combination of the inspection target actuator and the measurement actuator is registered.

6. The audio output device according to claim 5,
wherein a first actuator and a second actuator arranged in a vicinity of the inspection target actuator among the plurality of actuators are registered in the table as the measurement actuators in association with the inspection target actuator, and
the switching control unit determines the first actuator as the measurement actuator in a case where the first actuator is determined to be normal, and determines the second actuator as the measurement actuator in a case where the first actuator is determined to be abnormal.

7. The audio output device according to claim 6,
wherein as the first actuator, the actuator in which presence or absence of abnormality is determined before the inspection target actuator is registered in the table.

8. The audio output device according to claim 2, further comprising
a recording unit that records the reference signal for each combination of the inspection target actuator and the measurement actuator,
wherein the determination unit acquires the reference signal corresponding to the combination from the recording unit.

9. The audio output device according to claim 1,
wherein the diaphragm is a display substrate on which a light emitting element for displaying an image is arranged.

10. The audio output device according to claim 9, further comprising
a presentation control unit that presents presence or absence of abnormality of the inspection target actuator.

11. The audio output device according to claim 10,
wherein the presentation control unit causes the light emitting element arranged at a position corresponding to each of the plurality of actuators to emit light according to presence or absence of abnormality of the inspection target actuator.

12. The audio output device according to claim 9,
wherein the display substrate constitutes a tiling display.

13. The audio output device according to claim 1, further comprising
an audio output unit that is configured by combining a plurality of the diaphragms.

14. The audio output device according to claim 1, further comprising
a signal generation unit that generates an inspection signal for vibrating the inspection target actuator.

15. The audio output device according to claim 1,
wherein the actuator is a piezo actuator.

16. The audio output device according to claim 1,
wherein the actuator is a voice coil actuator.

17. An inspection method,
wherein an audio output device comprising
determining presence or absence of abnormality of an inspection target actuator on a basis of a displacement signal from a measurement actuator arranged in a vicinity of the inspection target actuator, the displacement signal being output in response to vibration of the inspection target actuator to be inspected among a plurality of actuators that vibrates a diaphragm from a back surface side to output audio from a front surface side of the diaphragm.
